(19) United States
(12) Patent Application Publication
(10) Pub. No.: US 2026/0205708 A1
(43) Pub. Date: Jul. 16, 2026

(54) ELECTRONIC DEVICE AND WHITE BALANCE ADJUSTING METHOD THEREOF

(71) Applicant: ASUSTeK COMPUTER INC., Taipei City (TW)

(72) Inventors: Hui-Chi Chuang, Taipei City (TW); Tzu-Shan Chang, Taipei City (TW)

(73) Assignee: ASUSTeK COMPUTER INC., Taipei City (TW)

(21) Appl. No.: 19/442,965

(22) Filed: Jan. 7, 2026

(30) Foreign Application Priority Data
Jan. 15, 2025 (TW) 114101642

(51) Int. Cl. H04N 23/88; H04N 23/56

(52) U.S. Cl. CPC H04N 23/88; H04N 23/56

(57) ABSTRACT

Provided are an electronic device and a white balance adjusting method thereof. The method includes the following steps. A flashlight device is used to emit a pre-flash and a pre-flash image is captured. A first white balance decision point is determined based on the pre-flash image. The flashlight device is turned off, and an ambient light image is captured using an image sensor. A second white balance decision point is determined based on the ambient light image. A final white balance decision point is determined based on a third white balance decision point corresponding to a main flash of the flashlight device, the first white balance decision point, and the second white balance decision point. A target image is captured using the flashlight device emitting the main flash, and the final white balance decision point is applied to adjust the white balance of the target image.

### CROSS-REFERENCE TO RELATED APPLICATION

This application claims the priority benefit of Taiwan application serial no. 114101642, filed on Jan. 15, 2025. The entirety of the above-mentioned patent application is hereby incorporated by reference herein and made a part of this specification.

### BACKGROUND

### Technical Field

This disclosure relates to an electronic device and a white balance adjusting method thereof.

### Related Art

With the advancement of technology, electronic devices equipped with camera systems have become ubiquitous in modern life. The Auto White Balance (AWB) algorithm is a key function in camera systems, used to automatically adjust the white balance of images, making captured photos appear with natural colors, especially under different lighting conditions. This is achieved by detecting color deviations in the image, and then adjusting the gain of the RGB channels to balance color distortions under different light sources. However, when shooting photos in various lighting environments, traditional AWB methods often fail to accurately estimate the color temperature changes caused by the flash in the scene, resulting in color cast or inconsistent color temperature issues in the images. These problems may degrade image quality and affect the experience of the end user.

### SUMMARY

The disclosure provides a white balance adjusting method for an electronic device including an image sensor and a flash device. The white balance adjusting method includes the following. The flash device is utilized to emit a pre-flash and a pre-flash image is captured. A first white balance decision point is determined based on the pre-flash image. The flash device is turned off and an ambient light image is captured through the image sensor. A second white balance decision point is determined based on the ambient light image. A final white balance decision point is determined based on a third white balance decision point corresponding to a main flash of the flash device, the first white balance decision point, and the second white balance decision point. The flash device is utilized to emit the main flash and a target image is captured, and the final white balance decision point is applied to conduct white balance adjustment on the target image.

The disclosure also provides an electronic device including an image sensor, a flash device, and a processor. The processor is coupled to the image sensor and the flash device. The processor is configured to: utilize the flash device to emit a pre-flash and capture a pre-flash image; determine a first white balance decision point based on the pre-flash image; turn off the flash device and capture an ambient light image through the image sensor; determine a second white balance decision point based on the ambient light image; determine a final white balance decision point based on a third white balance decision point corresponding to a main flash of the flash device, the first white balance decision point, and the second white balance decision point; utilize the flash device to emit the main flash and capture a target image, and apply the final white balance decision point to conduct white balance adjustment on the target image.

Based on the above, in the embodiment of this disclosure, the pre-flash image and the ambient light image are captured respectively under the conditions of turning on the pre-flash and turning off the flash device, and the first white balance decision point and the second white balance decision point are obtained based on the pre-flash image and the ambient light image respectively. In addition, the final white balance decision point is determined based on the third white balance decision point corresponding to the main flash, the first white balance decision point, the second white balance decision point, and the final white balance decision point are utilized to conduct white balance adjustment on the target image captured with the main flash turned on. Based on this, even if the color temperature or intensity of the pre-flash differs from the color temperature or intensity of the main flash, this disclosure may avoid color deviation produced when shooting with the main flash turned on, and ensure good white balance adjustment effects.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram of an electronic device according to an embodiment of this disclosure.

FIG. 2 is a flowchart of a white balance adjusting method according to an embodiment of this disclosure.

FIG. 3 is a schematic diagram of a white balance adjusting method according to an embodiment of this disclosure.

FIG. 4 is a flowchart of determining a final white balance decision point according to an embodiment of this disclosure.

FIG. 5 is a schematic diagram of determining a final white balance decision point according to an embodiment of this disclosure.

### DESCRIPTION OF THE EMBODIMENTS

Reference will now be made in detail to exemplary embodiments of this disclosure, examples of which are illustrated in the accompanying drawings. Wherever possible, the same reference numerals are used in the drawings and the description to refer to the same or similar parts. These embodiments are only a part of this disclosure and do not disclose all possible implementations of this disclosure. More precisely, these embodiments are only examples of the device and method in the scope of claims of this disclosure.

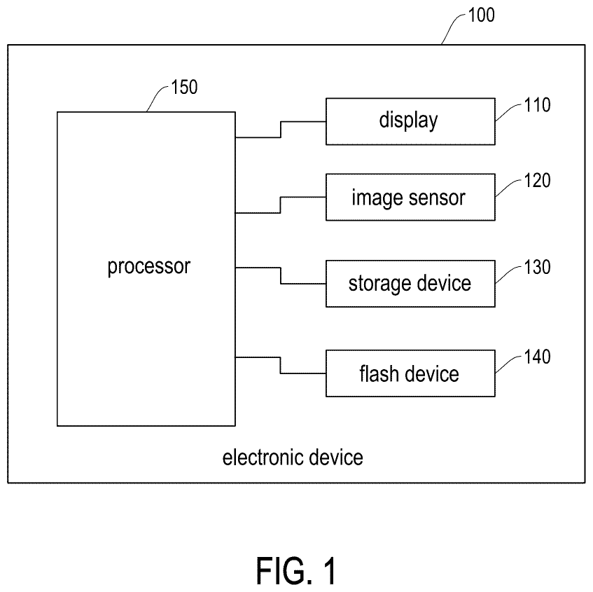

Referring to FIG. 1, an electronic device 100 may include a display 110, an image sensor 120, a storage device 130, a flash device 140, and a processor 150. In some embodiments, the electronic device 100 is a laptop computer, a tablet computer, a game console, a mobile phone, or other electronic devices with image capture function. This disclosure does not limit the type of electronic device.

In some embodiments, the display 110 is a Liquid Crystal Display (LCD), Light Emitting Diode (LED) display, Organic Light Emitting Diode (OLED) display, or other types of displays. This disclosure does not limit the type of display. The display 110 is used to display the program operation interface of the camera application, preview screen, or captured images, etc.

The image sensor 120 is used to provide image sensing function. In some embodiments, the image sensor 120 includes photosensitive elements, such as Charge Coupled Device (CCD), Complementary Metal-Oxide Semiconductor (CMOS) elements, or other elements. This disclosure does not limit the type of image sensor. The image sensor 120 may form the camera module of the electronic device 100 with other elements (such as lens, aperture).

The storage device 130 stores data, images, instructions, program codes, software modules, etc. In some embodiments, the storage device 130 is any type of fixed or removable random access memory (RAM), read-only memory (ROM), flash memory, hard disk or other similar devices, integrated circuits and combinations thereof.

The flash device 140 is used to emit flash to provide additional illumination during the image capture process. The flash device 140 includes one or more flash lights, and the color temperatures of these flash lights are the same or different. In the embodiment of this disclosure, the flash device 140 may emit a main flash and a pre-flash. The light intensity of the main flash is higher than that of the pre-flash. The flash device 140 may emit a pre-flash before the actual shooting, for example, one flash light of the flash device 140 may briefly flash once to help the camera with light metering. Through the pre-flash generated by the flash device 140, various shooting parameters, such as exposure parameters are determined based on the ambient light and the reflection of the subject. The flash device 140 emits the main flash during the actual shooting, and the main flash is used to enhance the brightness of the shooting target.

The processor 150 is coupled to the display 110, the image sensor 120, the storage device 130, and the flash device 140. In some embodiments, the processor 150 is a central processing unit (CPU), an application processor (AP), or other programmable general-purpose or special-purpose microprocessor, digital signal processor (DSP), image signal processor (ISP), graphics processing unit (GPU), or other similar devices, integrated circuits or combinations thereof. In some embodiments, the processor 150 executes instructions or program codes in the storage device 130 to implement various steps of the white balance adjusting method in the embodiment of this disclosure.

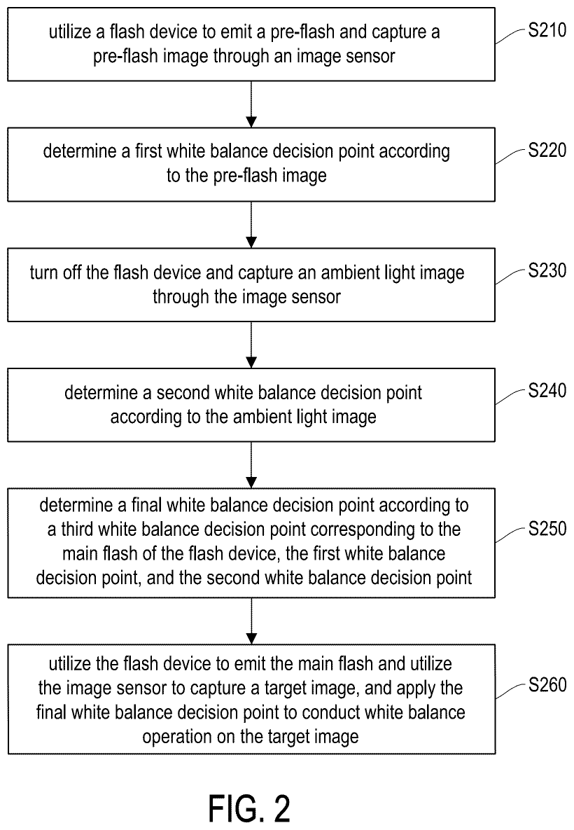

FIG. 2 is a flowchart of a white balance adjusting method according to an embodiment of this disclosure. Referring to FIG. 2, the method of this embodiment is executed by the electronic device 100 in FIG. 1. The details of each step in FIG. 2 are explained below in conjunction with the elements shown in FIG. 1.

In step S210, the processor 150 utilizes the flash device 140 to emit a pre-flash and captures a pre-flash image through the image sensor 120. In other words, when the flash device 140 emits a pre-flash to illuminate the shooting scene, the image sensor 120 captures the pre-flash image.

In step S220, the processor 150 determines a first white balance decision point according to the pre-flash image. Specifically, the processor 150 may determine the scene color temperature in a multi-light source (pre-flash and ambient light source) scene based on the pre-flash image. In the embodiment of this disclosure, the processor 150 may execute an Auto white balance (AWB) algorithm to determine a first white balance decision point in a coordinate plane according to the pre-flash image. The determination of the first white balance decision point is considered as the scene color temperature information estimated by the auto white balance algorithm, which is used to determine the color channel gain for white balance adjustment.

In some embodiments, the first white balance decision point may include two coordinate components, which are the red-green channel ratio (RG ratio) and the blue-green channel ratio (BG ratio). In some embodiments, the processor 150 may obtain multiple color channel values of multiple pixels in the pre-flash image. The processor 150 determines the first white balance decision point in the coordinate plane according to the red-green channel ratio of the red channel value to the green channel value for each pixel and the blue-green channel ratio of the blue channel value to the green channel value for each pixel. In some embodiments, these pixels are multiple white points detected based on white point detection of the auto white balance algorithm.

In some embodiments, the processor 150 may calculate multiple candidate white balance decision points corresponding to multiple white points in the pre-flash image, and converge these candidate white balance decision points to the first white balance decision point in the coordinate plane. For example, the processor 150 may calculate multiple red-green channel ratios of multiple white points, and determine the average of the red-green channel ratios as the red-green channel ratio of the first white balance decision point. Additionally, the processor 150 may calculate multiple blue-green channel ratios of multiple white points, and determine the average of the blue-green channel ratios as the blue-green channel ratio of the first white balance decision point. Alternatively, the processor 150 may determine the first white balance decision point corresponding to the pre-flash image according to multiple candidate white balance decision points based on other convergence algorithms.

In step S230, the processor 150 turns off the flash device 140 and captures an ambient light image through the image sensor 120. In other words, when the flash device 140 does not emit any flash to illuminate the shooting scene, the image sensor 120 captures the ambient light image. In some embodiments, the ambient light image and the pre-flash image are images captured by the image sensor 120 in a metering mode or a preview mode.

In step S240, the processor 150 determines a second white balance decision point according to the ambient light image. Specifically, the processor 150 may determine the scene color temperature when the flash device 140 is turned off according to the ambient light image. In the embodiment of this disclosure, the processor 150 may execute an auto white balance (AWB) algorithm to determine the second white balance decision point in a coordinate plane according to the ambient light image. The determination of the second white balance decision point is considered as the scene color temperature information estimated by the auto white balance algorithm, which is used to determine the color channel gain for white balance adjustment. It should be noted that the method by which the processor 150 calculates the second white balance decision point according to the ambient light image is similar to the method of calculating the first white balance decision point according to the pre-flash image. In other words, the processor 150 may determine the second white balance decision point according to multiple red-green channel ratios and multiple blue-green channel ratios of multiple white points in the ambient light image.

In step S250, the processor 150 determines a final white balance decision point according to a third white balance decision point corresponding to the main flash of the flash device 140, the first white balance decision point, and the second white balance decision point. In this disclosure, the third white balance decision point corresponding to the main flash of the flash device 140 is determined through prior testing and recorded in the storage device 130. In different embodiments, through table lookup or function calculation, the processor 150 may determine the final white balance decision point according to the first white balance decision point, the second white balance decision point, and the third white balance decision point.

From another perspective, when the light source of the actual shooting environment includes the ambient light and the main flash of the flash device 140, the processor 150 may estimate the scene color temperature information with the main flash turned on according to the color temperature information of the main flash and the color temperature information of the ambient light, to determine more ideal color channel gains. The third white balance decision point corresponding to the main flash may represent the color temperature information of the main flash, which is obtained through prior testing and recorded in the storage device 130. The second white balance decision point may represent the color temperature information of the ambient light, which is estimated according to the real-time captured ambient light image. In addition, by referring to the color temperature information of the pre-flash shooting scene, this disclosure may make the color temperature estimation of the actual shooting scene with the main flash turned on closer to the real situation, to determine color channel gains that are more in line with actual needs.

In step S260, the processor 150 utilizes the flash device 140 to emit the main flash and utilizes the image sensor 120 to capture the target image, and applies the final white balance decision point to conduct white balance operation on the target image. Specifically, after determining the final white balance decision point, the processor 150 may control the flash device 140 to emit the main flash and drive the image sensor 120 to capture the target image in response to the shutter signal. Moreover, the processor 150 may utilize the final white balance decision point to determine multiple color channel gains, and utilize these color channel gains to adjust the color channel values of each pixel of the target image to implement white balance adjustment. For instance, the processor 150 may utilize the final white balance decision point to determine the red channel gain, and utilize this red channel gain to adjust the red channel values of each pixel of the target image.

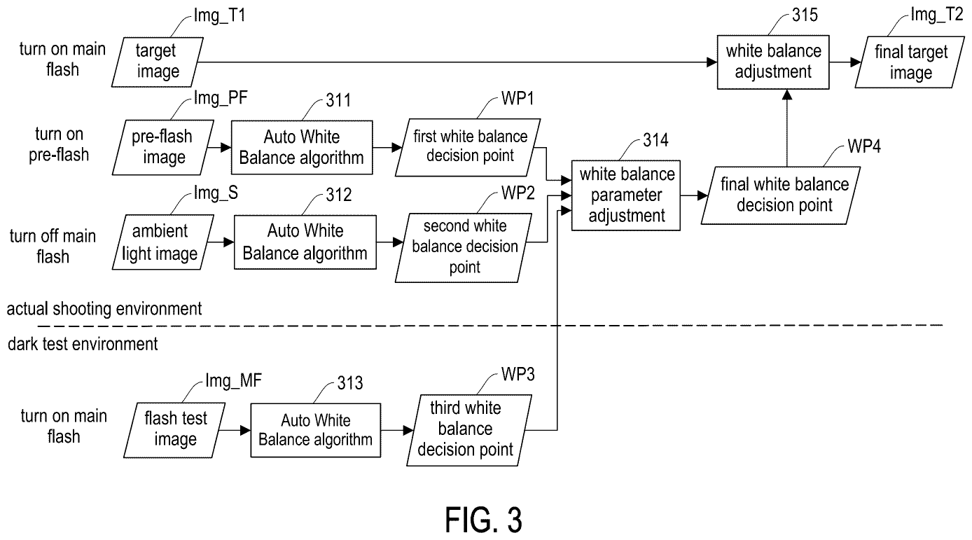

FIG. 3 is a schematic diagram of a white balance adjusting method according to an embodiment of this disclosure. In some embodiments, the third white balance decision point associated with the main flash is determined through prior testing. In a dark test environment, the processor 150 may turn on the main flash to capture a flash test image Img_MF. Specifically, in some embodiments, in a dark environment, the processor 150 utilizes the flash device 140 to emit the main flash and captures a flash test image Img_MF through the image sensor 120. The processor 150 determines a third white balance decision point WP3 according to the flash test image Img_MF. That is, in operation 313, the processor 150 may implement the AWB algorithm according to the flash test image Img_MF to estimate the color temperature information of the main flash, thereby obtaining the third white balance decision point WP3.

In the actual shooting environment, the processor 150 may turn on the pre-flash to capture a pre-flash image Img_PF, and turn off the flash device 140 to capture an ambient light image Img_S. In operation 311, the processor 150 may implement the AWB algorithm according to the pre-flash image Img_PF to obtain a first white balance decision point WP1. In operation 312, the processor 150 may implement the AWB algorithm according to the ambient light image Img_S to obtain a second white balance decision point WP2.

In operation 314, the processor 150 may determine a final white balance decision point WP4 according to the first white balance decision point WP1, the second white balance decision point WP2, and the third white balance decision point WP3. That is, the processor 150 may determine a final white balance decision coordinate according to three white balance decision coordinates on the coordinate plane. Thus, in response to receiving the shutter signal, the processor 150 may utilize the flash device 140 to emit the main flash and capture a target image Img_T1 through the image sensor 120. In operation 315, the processor 150 may conduct white balance adjustment on the target image Img_T1 according to the final white balance decision point WP4, to obtain a final target image Img_T2.

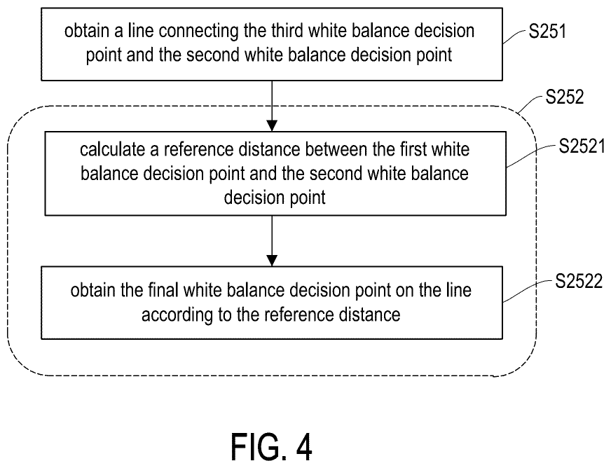

FIG. 4 is a flowchart of determining a final white balance decision point according to an embodiment of this disclosure. In some embodiments, in step S251, the processor 150 may obtain a line between the third white balance decision point and the second white balance decision point. In step S252, the processor 150 determines the final white balance decision point located on the line according to the first white balance decision point. That is, assuming that the final white balance decision point is positioned between the third white balance decision point associated with the main flash and the second white balance decision point associated with the ambient light, the processor 150 may search for the final white balance decision point on the line between the third white balance decision point and the second white balance decision point.

In some embodiments, step S252 is implemented as steps S2521 to S2522. In step S2521, the processor 150 calculates a reference distance between the first white balance decision point and the second white balance decision point. In step S2522, the processor 150 obtains the final white balance decision point on the line according to the reference distance. That is, the processor 150 may search for the final white balance decision point on the line between the third white balance decision point and the second white balance decision point by referring to the position of the first white balance decision point.

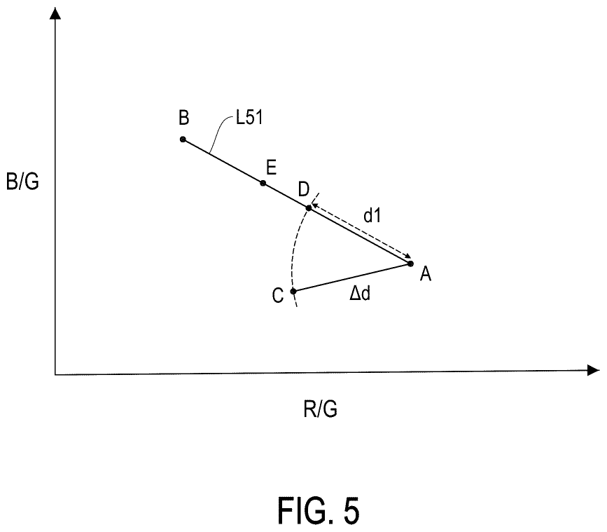

For example, referring to FIG. 5, through prior testing, the processor 150 may determine a third white balance decision point B associated with the main flash on the coordinate plane. In the actual shooting environment, the processor 150 may obtain a second white balance decision point A on the coordinate plane by turning off the flash, and may obtain a first white balance decision point C on the coordinate plane by turning on the pre-flash. The horizontal axis of the coordinate plane represents the ratio (R/G) of the red channel value to the green channel value, and the vertical axis of the coordinate plane represents the ratio (B/G) of the blue channel value to the green channel value.

Next, the processor 150 may obtain a line L51 between the third white balance decision point B and the second white balance decision point A. The processor 150 calculates a reference distance Δd between the first white balance decision point C and the second white balance decision point A. The processor 150 obtains a final white balance decision point E on the line L51 according to the reference distance Δd. In some embodiments, the distance between the final white balance decision point E and the second white balance decision point A is equal to the product of an adjustable parameter and the reference distance Δd.

In some embodiments, the processor 150 may obtain a reference point D on the line L51 according to the reference distance Δd. A distance d1 between the reference point D and the second white balance decision point A is equal to the reference distance Δd. The processor 150 may determine the final white balance decision point E located on the line L51 according to the reference point D and an adjustable parameter.

Referring to FIG. 5, the X-axis of the coordinate plane represents the ratio (R/G) of the red channel value to the green channel value, and the Y-axis of the coordinate plane represents the ratio (B/G) of the blue channel value to the green channel value. It is assumed that the coordinate of the first white balance decision point C is (x_{C}, y_{C}), the coordinate of the second white balance decision point A is (x_{A}, y_{A}), and the coordinate of the third white balance decision point B is (x_{B}, y_{B}). The processor 150 may find a reference point D on the line segment A̅B̅, such that A̅D̅=A̅C̅. The coordinate of the reference point D (x_{D}, y_{D}) is expressed as in the following formula (1) and formula (2).

$${x}_{D} = {x}_{A} + t \cdot ( {x}_{B} - {x}_{A} ) \qquad formula ( 1 )$$

$${y}_{D} = {y}_{A} + t \cdot ( {y}_{B} - {y}_{A} ) \qquad formula ( 2 )$$

where t represents a ratio value.

Based on A̅D̅=t·A̅B̅=A̅C̅, the processor 150 may calculate t as shown in formula (1)

$$t = \sqrt{\frac{{( {x}_{C} - {x}_{A} )}^{2} + {( {y}_{C} - {y}_{A} )}^{2}}{{( {x}_{B} - {x}_{A} )}^{2} + {( {y}_{B} - {y}_{A} )}^{2}}} \qquad formula ( 3 )$$

Therefore, the processor 150 may obtain the coordinate (x_{E}, y_{E}) of the final white balance decision point E according to the following formula (4) and formula (5), where k represents an adjustable parameter, which is an integer greater than 0. Subsequently, the processor 150 may determine the color channel gain to be applied to each color channel based on the coordinate (x_{E}, y_{E}) of the final white balance decision point E. Regarding the part of determining the color channel gain for each color channel according to the final white balance decision point E, various automatic white balance algorithms are applied to accomplish this, without specific limitations.

$${x}_{E} = {x}_{A} + k \cdot ( {x}_{D} - {x}_{A} ) = {x}_{A} + k \cdot t \cdot ( {x}_{B} - {x}_{A} ) \qquad formula ( 4 )$$

$${y}_{E} = {y}_{A} + k \cdot ( {y}_{D} - {y}_{A} ) = {y}_{A} + k \cdot t \cdot ( {y}_{B} - {y}_{A} ) \qquad formula ( 5 )$$

In summary, in the embodiments of this disclosure, the final white balance decision point is determined based on the third white balance decision point decided by the main flash, the first white balance decision point decided by the pre-flash, and the second white balance decision point decided by the ambient light. The final white balance decision point is then utilized to conduct white balance adjustment on the target image captured with the main flash turned on. Based on this, even if the color temperature or intensity of the pre-flash differs from the color temperature or intensity of the main flash, this disclosure may avoid color deviation produced when shooting with the main flash turned on, and ensure good white balance adjustment effects. Furthermore, compared to directly using the first white balance decision point corresponding to the pre-flash to adjust the white balance of the target image captured based on the main flash, the method of this disclosure, by comprehensively considering white balance decision results under different lighting environments to select the final white balance decision point for conducting white balance adjustment, can effectively avoid color deviation.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A white balance adjusting method for an electronic device comprising an image sensor and a flash device, the method comprising:
utilizing the flash device to emit a pre-flash and capturing a pre-flash image;
determining a first white balance decision point based on the pre-flash image;
turning off the flash device and capturing an ambient light image through the image sensor;
determining a second white balance decision point based on the ambient light image;
determining a final white balance decision point based on a third white balance decision point corresponding to a main flash of the flash device, the first white balance decision point, and the second white balance decision point; and
utilizing the flash device to emit the main flash and capturing a target image, and applying the final white balance decision point to conduct white balance adjustment on the target image.

2. The white balance adjusting method according to claim 1, wherein determining the final white balance decision point based on the third white balance decision point corresponding to the main flash of the flash device, the first white balance decision point, and the second white balance decision point comprises:
obtaining a line between the third white balance decision point and the second white balance decision point; and
determining the final white balance decision point positioned on the line based on the first white balance decision point.

3. The white balance adjusting method according to claim 2, wherein determining the final white balance decision point positioned on the line based on the first white balance decision point comprises:
calculating a reference distance between the first white balance decision point and the second white balance decision point; and
obtaining the final white balance decision point on the line based on the reference distance.

4. The white balance adjusting method according to claim 3, wherein obtaining the final white balance decision point on the line based on the reference distance comprises:
obtaining a reference point on the line based on the reference distance, wherein a distance between the reference point and the second white balance decision point is equal to the reference distance; and
determining the final white balance decision point positioned on the line based on the reference point and an adjustable parameter.

5. The white balance adjusting method according to claim 3, wherein a distance between the final white balance decision point and the second white balance decision point is equal to a product of an adjustable parameter and the reference distance.

6. The white balance adjusting method according to claim 1 further comprising:
in a dark environment, utilizing the flash device to emit the main flash and capturing a flash test image; and
determining the third white balance decision point based on the flash test image.

7. The white balance adjusting method according to claim 1, wherein determining the first white balance decision point based on the pre-flash image comprises:
obtaining a plurality of color channel values of a plurality of pixels in the pre-flash image; and
determining the first white balance decision point in a coordinate plane based on a red-green channel ratio of a red channel value to a green channel value for each of the pixels and a blue-green channel ratio of a blue channel value to a green channel value for the each of the pixels.

8. An electronic device, comprising:
an image sensor;
a flash device; and
a processor, coupled to the image sensor and the flash device, and configured to:
utilize the flash device to emit a pre-flash and capture a pre-flash image;
determine a first white balance decision point based on the pre-flash image;
turn off the flash device and capture an ambient light image through the image sensor;
determine a second white balance decision point based on the ambient light image;
determine a final white balance decision point based on a third white balance decision point corresponding to a main flash of the flash device, the first white balance decision point, and the second white balance decision point; and
utilize the flash device to emit the main flash and capture a target image, and apply the final white balance decision point to conduct white balance adjustment on the target image.

9. The electronic device according to claim 8, wherein the processor is configured to:
obtain a line between the third white balance decision point and the second white balance decision point; and
determine the final white balance decision point positioned on the line based on the first white balance decision point.

10. The electronic device according to claim 9, wherein the processor is further configured to:
calculate a reference distance between the first white balance decision point and the second white balance decision point; and
obtain the final white balance decision point on the line based on the reference distance.

11. The electronic device according to claim 10, wherein the processor is further configured to:
obtain a reference point on the line based on the reference distance, wherein a distance between the reference point and the second white balance decision point is equal to the reference distance; and
determine the final white balance decision point positioned on the line based on the reference point and an adjustable parameter.

12. The electronic device according to claim 10, wherein a distance between the final white balance decision point and the second white balance decision point is equal to a product of an adjustable parameter and the reference distance.

13. The electronic device according to claim 8, wherein the processor is further configured to:
in a dark environment, utilize the flash device to emit the main flash and capture a flash test image; and
determine the third white balance decision point based on the flash test image.

14. The electronic device according to claim 8, wherein the processor is further configured to:
obtain a plurality of color channel values of a plurality of pixels in the pre-flash image; and
determine the first white balance decision point in a coordinate plane based on a red-green channel ratio of a red channel value to a green channel value for each of the pixels and a blue-green channel ratio of a blue channel value to a green channel value for the each of the pixels.
